(19) United States
(12) Patent Application Publication
(10) Pub. No.: US 2006/0012546 A1
(43) Pub. Date: Jan. 19, 2006

(54) Plasma display apparatus and image processing method thereof

(76) Inventors: Seong Hak Moon, Seoul (KR); Byung Soo Song, Goyang-si (KR)

Correspondence Address: MCKENNA LONG & ALDRIDGE LLP, 1900 K STREET, NW, WASHINGTON, DC, 20006, US

(21) Appl. No.: 11/201,204

(22) Filed: Aug. 11, 2005

(30) Foreign Application Priority Data
Apr. 11, 2004 (KR) 10-2004-0063326

(51) Int. Cl. G09G 3/28

(52) U.S. Cl. 345/60

(57) ABSTRACT

The present invention relates to a plasma display apparatus, and more particularly, to a plasma display apparatus for representing gray levels and image processing method thereof. According to the present invention, the plasma display apparatus includes an object division unit for detecting an edge from a received m-bit image signal and dividing an object surrounded by the edge, and an image signal conversion unit for dividing between-gray levels of pixels constituting the divided object and converting the m-bit image signal into a n-bit image signal (where n is a natural number greater than m). By finely dividing between-gray levels allocated to pixels corresponding to a divided object, the gray linearity can be secured.

### CROSS-REFERENCES TO RELATED APPLICATIONS

This Nonprovisional application claims priority under 35 U.S.C. § 119(a) on Patent Application No. 10-2004-0063326 filed in Korea on Aug. 11, 2004 the entire contents of which are hereby incorporated by reference.

### BACKGROUND OF THE INVENTION

1. Field of the Invention

The present invention relates to a plasma display apparatus, and more particularly, to a plasma display apparatus for representing gray levels and a image processing method thereof.

2. Background of the Related Art

FIG. 1 shows a sub-field configuration of an Address-Sustain Separation (ADS) driving method for driving a typical plasma display apparatus. As shown in FIG. 1, an image signal corresponding to one frame is divided into eight sub-fields. Each of the sub-fields includes a reset period, an address period and a sustain period.

In the reset period, all discharge cells are discharged and are thus initialized. In the address period, discharge cells for which display is required are selected according to an input image signal. The sustain period is a period where the discharge cells selected in the address period are sustained for display.

The sustain period of each of the sub-fields is allocated with a weight value as a display period. These sub-fields are combined to represent a multi-gray level. At this time, after sustain discharge of the sustain period of each sub-field is completed, an erasing period for controlling the level of wall charges accumulated on cells in order display a next sub-field comes next.

The gray level number that can be represented using eight sub-fields is 2⁸, i.e., 256. The plasma display apparatus can represent 256 gray levels using an 8-bit image signal.

Recently, there is a trend that a plasma display apparatus will support a high contrast ratio and high brightness. When a plasma display apparatus supports a high contrast ratio and high brightness, a problem anises in that a difference in the amount of light between gray levels increases.

FIGS. 2a and 2b are views for explaining a difference in the amount of light between gray levels depending on variations in the peak brightness of a plasma display apparatus. There is shown in FIG. 2a the amount of light for each of the 256 gray levels when the peak brightness is 500 cd/m². Further, there is shown in FIG. 2b the amount of light for each of the 256 gray levels when the peak brightness is 1000 cd/m².

When the peak brightness is 500 cd/m² and the gray levels are 256, a difference in the amount of light between the gray levels is 1 to 2 cd. When the peak brightness is 1000 cd/m² and the gray levels are 256, however, a difference in the amount of light between gray levels is 3 to 4 cd.

If the difference in the amount of light between gray levels is low, variations in the amount of light in each gray level can be seen by human eye without assistance, as shown in FIG. 2a. If the difference in the amount of light between gray levels is high, however, variations in the amount of light in each gray level are high. Accordingly, the variations in the amount of light in each gray label will be seen by the human eyes as if a step exists between the gray levels, as shown in FIG. 2b.

If a difference in the amount of light between gray levels increases as the brightness of the plasma display apparatus increases, a problem of degradation of gray linearity occurs.

These problems are not limited only to a plasma display apparatus, but occur with respect to all ohter display apparatuses for processing images using received m-bit image signals.

### SUMMARY OF THE INVENTION

According to the present invention, there is provided a plasma display apparatus, including a) an object division unit for detecting an edge from a received m-bit image signal and dividing an object surrounded by the edge, and b) an image signal conversion unit for dividing between-gray levels of pixels constituting the divided object and converting the m-bit image signal into an n-bit image signal (where n is a natural number greater than m).

According to the present invention, there is provided an image processing method of a plasma display apparatus, including the steps of a) detecting an edge from a received m-bit image signal and dividing an object surrounded by the edge, and b) dividing between-gray levels of pixels constituting the divided object and converting the m-bit image signal into an n-bit image signal (where n is a natural number greater than m).

According to the present invention, the gray linearity can be improved by finely dividing gray levels allocated to pixels corresponding to a divided object.

According to the present invention, there is provided a plasma display apparatus, including an object division unit for detecting an edge from a received m-bit image signal and dividing an object surrounded by the edge, and an image signal conversion unit for dividing between-gray levels of pixels constituting the divided object and converting the m-bit image signal into an n-bit image signal (where n is a natural number greater than m).

The object division unit can include an edge detector for detecting the edge using a boundary condition.

The edge detector can detect the edge using the boundary condition in which a difference between gray levels of the object and gray levels of portions other than the object and a reference gray level difference are compared.

The edge detector is one of a Sobel edge detector, a Prewitt edge detector or a Canny edge detector.

The object division unit can detect the edge and then divides the object surrounded by the edge using a region growing method.

The image signal conversion unit can convert an 8-bit image signal corresponding to the divided object into an image signal of 10 bit or more.

The image signal conversion unit can divide between-gray levels using an interpolation method.

The image signal conversion unit can divide between-the-gray levels using a bilinear interpolation method.

The image signal conversion unit can divide between-the-gray levels using the bilinear interpolation method employing the following Equation.
E=(1−α)A+αB
F=(1−α)C+αD
X=(1−β)E+βF
A, B, C and D: the gray level of far-sightedness pixel
E and F: the gray level of X-axis interpolation pixel
X: the gray level of a last pixel
α and β: weight

According to the present invention, there is provided an image processing method of a plasma display apparatus, including the steps of detecting an edge from a received m-bit image signal and dividing an object surrounded by the edge, and dividing between-gray levels of pixels constituting the divided object and converting the m-bit image signal into an n-bit image signal (where n is a natural number greater than m).

The edge can be detected using a boundary condition.

The boundary condition can include comparing a difference between gray levels of the object and gray levels of portions other than the object and a reference gray level difference.

The edge can be detected using a Sobel edge detecting method, a Prewitt edge detecting method or a Canny edge detecting method.

The division of the object surrounded by the edge can be performed by detecting the edge and then dividing the object surrounded by the edge using a region-growing method.

The m-bit image signal can be an 8-bit image signal, and the n-bit image signal can be an image signal of 10 bits or more.

The division of between-the-gray levels can be performed using an interpolation method.

The interpolation method can be a bilinear interpolation method.

Between-the-gray levels can be divided using a bilinear interpolation method employing the following Equation.
E=(1−α)A+αB
F=(1−α)C+αD
X=(1−β)E+βF
A, B, C and D: the gray level of far-sightedness pixel
E and F: the gray level of X-axis interpolation pixel
X: the gray level of a last pixel
α and β: weight

### BRIEF DESCRIPTION OF THE DRAWINGS

The invention can be more fully understood from the following detailed description taken in conjunction with the accompanying drawings in which:

FIG. 1 shows a sub-field configuration of the ADS driving method for driving the typical plasma display apparatus;

FIGS. 2a and 2b are views for explaining a difference in the amount of light between gray levels depending on variations in the peak brightness of the plasma display apparatus;

FIG. 3 is a view for explaining the operation of a plasma display apparatus and a basic concept of an image processing method according to the present invention;

FIG. 4 is a block diagram of the plasma display apparatus according to the present invention;

FIG. 5 is a view for explaining the operation of an object division unit according to the present invention;

FIG. 6 is a view for explaining the concept of a bilinear interpolation method used in the image processing method of the present invention; and

FIG. 7 is a flowchart illustrating the image processing method of the plasma display apparatus according to the present invention.

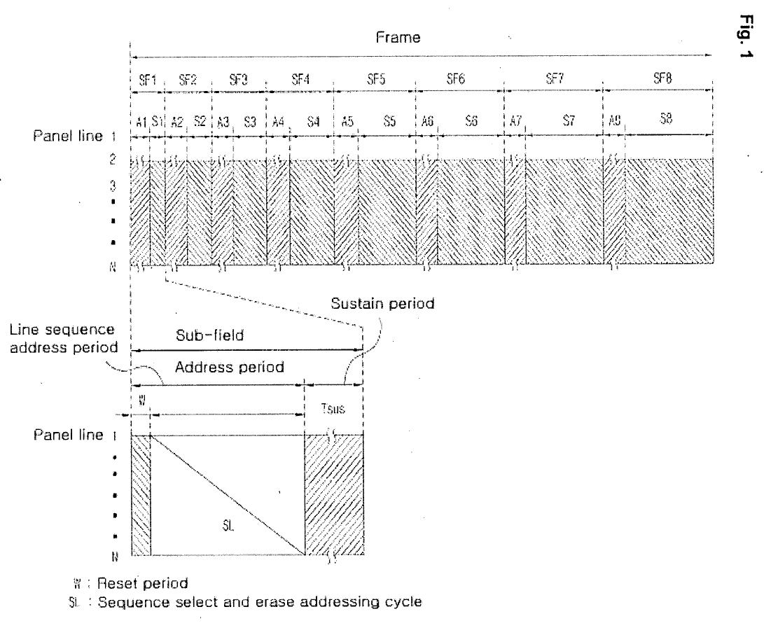

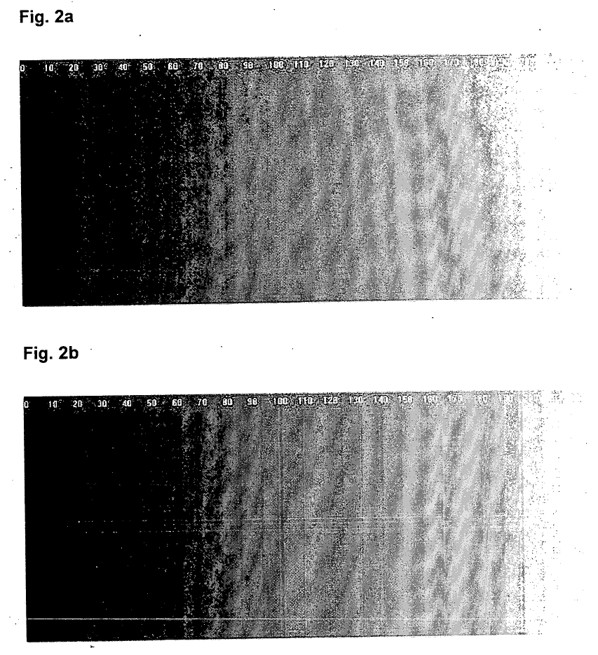

### DETAILED DESCRIPTION OF THE PREFERRED EMBODIMENT

The present invention will now be described in detail in connection with preferred embodiments with reference to the accompanying drawings.

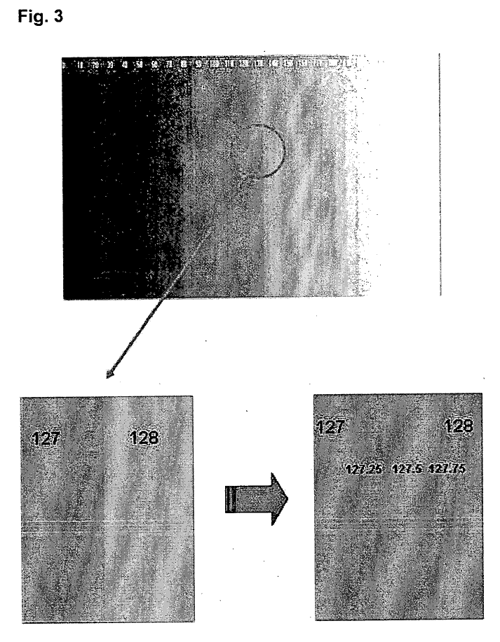

FIG. 3 is a view for explaining the operation of a plasma display apparatus and a basic concept of an image processing method according to the present invention. As shown in FIG. 3, in the image processing method of the present invention, since a difference in the amount of light between gray levels is high, the gray levels are quartered in order to represent the gray levels.

The difference in the amount of light between a 127^{th} gray level and a 128^{th} gray level is high. In the image processing method of the present invention quarters the, between-the 127^{th} gray level and the 128^{th} gray level (i.e., an 8-bit image signal) to generate an 127.25 gray level, an 127.50 the gray level and an 127.75 gray level.

If image processing method is performed on the whole 256 gray levels, the 256 gray levels are converted into 1024 (256×4) gray levels. Thus, the 8-bit image signal is converted into a 10-bit image signal.

When the plasma display apparatus displays a predetermined amount of peak brightness such as 1000 cd/m², the gray levels from 256 to 1024 increases number of the image processing method according to the present invention. Accordingly, the amount of light between the gray levels is reduced in a manner proportionate to the gray levels in the number of and the gray linearity of the plasma display apparatus is improved as a result.

FIG. 3 illustrates the image processing method of the present invention. If between-the-gray levels are equally divided by a more than 4 times, the 8-bit image signal can be converted into an image signal of 10 bits or more.

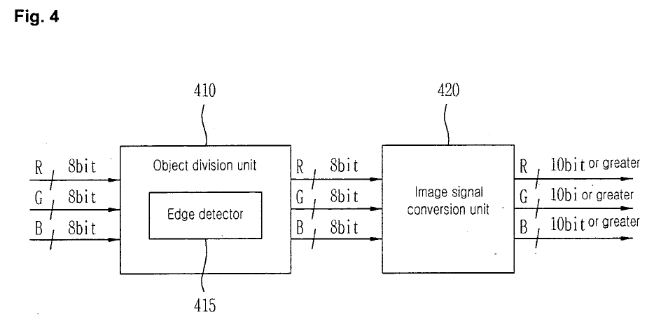

FIG. 4 is a block diagram of a plasma display apparatus according to the present invention. Referring to FIG. 4, the plasma display apparatus according to the present invention includes an object division unit 410 and an image signal conversion unit 420.

The object division unit 410 detects an edge from a received m-bit image signal, and divides an object surrounded by the edge. For example, the object division unit 410 can analyze an 8-bit image signal on a pixel basis, and separates an object from images represented by the 8-bit image signal. The object division unit 410 includes an edge detector 415 for detecting an edge using a boundary condition between objects or a boundary condition between an object and a background.

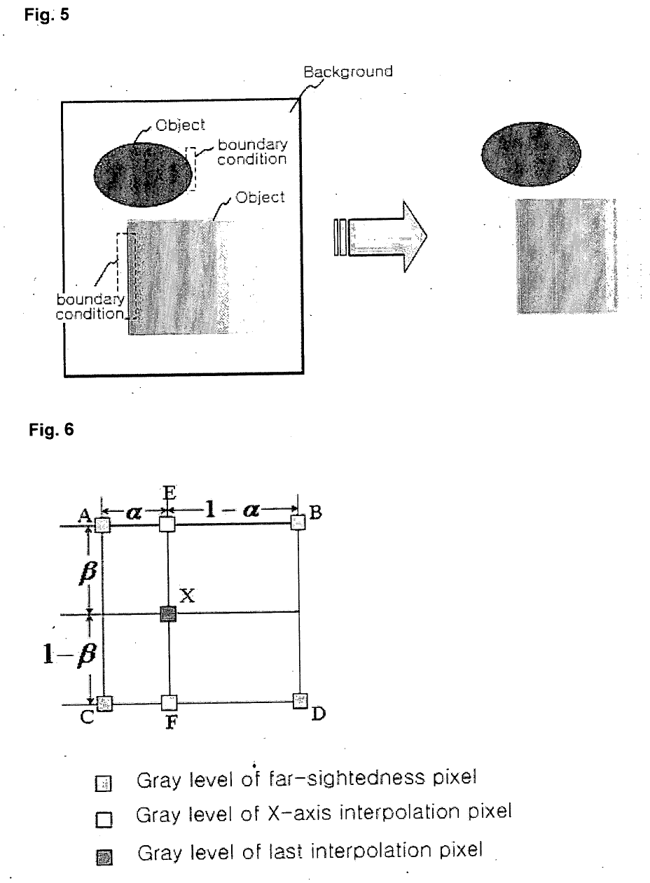

The object division unit 415 detects the edge of the object using the boundary condition between the object and the background, and divides each object using a region-growing method with a boundary characteristic of the object remained intact, as shown in FIG. 5.

In this case, the term “background” refers to images other than an object to be divided. The boundary condition is determined by comparing a gray level difference between the object and the background or the objects, and a reference gray level difference.

The edge detector can include a Sobel edge detector, a Prewitt edge detector, a Canny edge detector or the like. Furthermore, a method such as Watershed can also be used in order to divide an object.

The image signal conversion unit 420 divides between-gray levels of pixels constituting the object divided by the object division unit 410, and converts an m-bit image signal into an n-bit image signal (where n is a natural number greater than m). For instance, between-gray levels of pixels constituting a divided object can be divided, an 8-bit image signal can be converted into an image signal of 10 bits or more on an object basis, and the converted image signal can be then allocated. At this time, the image signal conversion unit 420 divides between-the-gray levels using an interpolation method.

FIG. 6 is a view for explaining the concept of a bilinear interpolation method used in the image processing method of the present invention. As shown in FIG. 6, the gray level of the last pixel is the sum of values in which gray levels (A, B, C and D) of four pixels which are the nearest to each other are multiplied by weights according to the bilinear interpolation method. The gray level of the last pixel according to this bilinear interpolation method can be expressed in the following Equation 1.
E=(1−α)A+αB
F=(1−α)C+αD
X=(1−β)E+βF
A, B, C and D: the gray level of far-sightedness pixel
E and F: the gray level of X-axis interpolation pixel
X: the gray level of the last pixel
α and β: weight

For example, assuming that A, B, C and D indicate gray levels depending on an 8-bit image signal, between-A and B and between-A and B can be quartered through control of the weight (α and β). The gray levels depending on the 8-bit image signal can be converted into gray levels depending on a 10-bit image signal through this process.

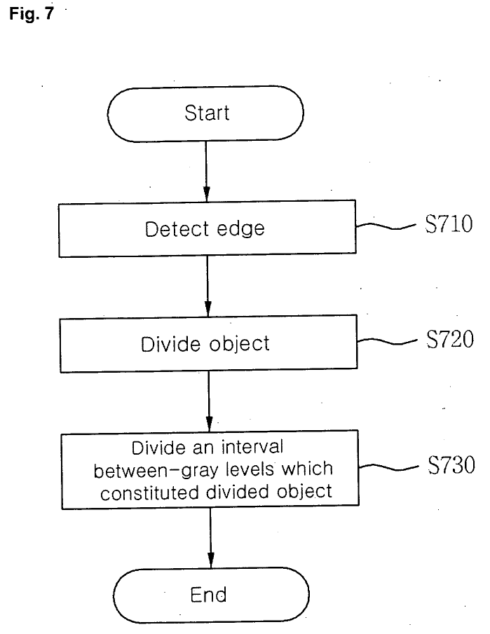

FIG. 7 is a flowchart illustrating the image processing method of the plasma display apparatus according to the present invention.

The edge detector 415 of the object division unit 410 detects an edge from a received m-bit image signal (S710). For example, the edge detector 415 of the object division unit 410 can analyze an 8-bit image signal on a pixel basis to detect an edge of an object to be divided. At this time, in order to divide the object, the edge is detected using an boundary condition. In this case, the boundary condition can be determined by comparing a gray level difference between the object and the background or the objects, and a reference gray level difference. As such, the edge detection method using the boundary condition can employ a Sobel edge detecting method, a Prewift edge detecting method, a Canny edge detecting method or the like.

The object division unit 410 divides the object surrounded by the edge detected by the edge detector 415 (S720). At this time, the division of the object surrounded by the edge can be performed by detecting the edge and then dividing the object surrounded by the edge using the region-growing method. As such, if the edge of the object is detected, an m-bit image signal corresponding to the object is divided.

The image signal conversion unit 420 divides between-gray levels which constituted the divided object by the interpolation method such as the bilinear interpolation method, and converts the m-bit image signal corresponding to each object into an image signal of n-bit or higher (where n is a natural number greater than m) by the interpolation method such as a bilinear interpolation method (S730). The bilinear interpolation method is for dividing an interval between gray levels. At this time, the m-bit image signal is preferably an 8-bit image signal, and the n-bit image signal is preferably an image signal of 10 bits or more. The bilinear interpolation method has been described in detail above, and a description thereof will be omitted.

According to the present invention as described above, by finely dividing between-gray levels, the gray linearity in a plasma display apparatus with high brightness can be secured.

The image processing apparatus and image processing method according of the present invention are not limited to a plasma display apparatus, but can be applied to all display apparatuses for processing images using received m-bit image signals.

The present invention while described here in with reference to particular illustrative embodiments, need not be restricted by such embodiments but only by the appended claims. Those skilled in the art can change or modify the embodiments without departing from the scope and spirit of the present invention.

What is claimed is:

1. A plasma display apparatus, comprising:
an object division unit for detecting an edge from a received m-bit image signal and dividing an object surrounded by the edge; and
an image signal conversion unit for dividing between-gray levels of pixels constituting the divided object and converting the m-bit image signal into an n-bit image signal (where n is a natural number greater than m).

2. The plasma display apparatus as claimed in claim 1, wherein the object division unit includes an edge detector for detecting the edge using a boundary condition.

3. The plasma display apparatus as claimed in claim 2, wherein the edge detector detects the edge using the boundary condition in which a difference between gray levels of the object and gray levels of portions other than the object and a reference gray level difference are compared.

4. The plasma display apparatus as claimed in claim 2, wherein the edge detector is one of a Sobel edge detector, a Prewitt edge detector or a Canny edge detector.

5. The plasma display apparatus as claimed in claim 1, wherein the object division unit detects the edge and then divides the object surrounded by the edge using a region growing method.

6. The plasma display apparatus as claimed in claim 1, wherein the image signal conversion unit converts an 8-bit image signal corresponding to the divided object into an image signal of 10 bit or more.

7. The plasma display apparatus as claimed in claim 1, wherein the image signal conversion unit divides between-gray levels using an interpolation method.

8. The plasma display apparatus as claimed in claim 7, wherein the image signal conversion unit divides between-the-gray levels using a bilinear interpolation method.

9. The plasma display apparatus as claimed in claim 8, wherein the image signal conversion unit divides between-the-gray levels using the bilinear interpolation method employing the following Equation.
E=(1−α)A+αB
F=(1−α)C+αD
X=(1−β)E+βF
A, B, C and D: the gray level of far-sightedness pixel
E and F: the gray level of X-axis interpolation pixel
X: the gray level of a last pixel
α and β: weight

10. An image processing method of a plasma display apparatus, comprising the steps of:
detecting an edge from a received m-bit image signal and dividing an object surrounded by the edge; and
dividing between-gray levels of pixels constituting the divided object and converting the m-bit image signal into an n-bit image signal (where n is a natural number greater than m).

11. The image processing method as claimed in claim 10, wherein the edge is detected using a boundary condition.

12. The image processing method as claimed in claim 11, wherein the boundary condition includes comparing a difference between gray levels of the object and gray levels of portions other than the object and a reference gray level difference.

13. The image processing method as claimed in claim 11, wherein the edge is detected using a Sobel edge detecting method, a Prewitt edge detecting method or a Canny edge detecting method.

14. The image processing method as claimed in claim 10, wherein the division of the object surrounded by the edge is performed by detecting the edge and then dividing the object surrounded by the edge using a region-growing method.

15. The image processing method as claimed in claim 10, wherein the m-bit image signal is an 8-bit image signal, and the n-bit image signal is an image signal of 10 bits or more.

16. The image processing method as claimed in claim 10, wherein the division of between-the-gray levels is performed using an interpolation method.

17. The image processing method as claimed in claim 16, wherein the interpolation method is a bilinear interpolation method.

18. The image processing method as claimed in claim 17, wherein between-the-gray levels is divided using a bilinear interpolation method employing the following Equation.
E=(1−α)A+αB
F=(1−α)C+αD
X=(1−β)E+βF
A, B, C and D: the gray level of far-sightedness pixel
E and F: the gray level of X-axis interpolation pixel
X: the gray level of a last pixel
α and β: weight
